(19) United States
(12) Patent Application Publication
(10) Pub. No.: US 2022/0079713 A1
(43) Pub. Date: Mar. 17, 2022

(54) COMPOUND DENTAL FLOSS TIE

(71) Applicant: Osama Adnan AL KHATIB, Doha (QA)

(72) Inventor: Osama Adnan AL KHATIB, Doha (QA)

(21) Appl. No.: 17/019,467

(22) Filed: Sep. 14, 2020

(51) Int. Cl. A61C 5/82; A61C 15/04

(52) U.S. Cl. CPC A61C 5/82; A61C 15/041

(57) ABSTRACT

Compound dental floss is a single loop or double loop self-ligaturing tie tied to its loop one, two or multiple regular ties. It is used for rubber dam isolation to hold rubber dam sheet in place around the teeth and prevent it from moving or sliding during dental treatment.

### BACKGROUND OF THE INVENTION

### 1. The Field of the Invention

The present invention relates to the use of rubber dams in dentistry, and more particularly to new dental floss tie to hold the rubber dam sheet in place around the prepared teeth while performing a dental procedure.

### 2. Background

rubber dam is simply a thin sheet of rubber that is clamped around the tooth or teeth that will be worked on by dentists, it was introduced into dentistry about 1864, in order to ensure complete dryness and cleanliness of the teeth. More particularly, a rubber dam is used to isolate a tooth or the individual teeth being treated. It eliminates saliva from the location of treatment and guards against contamination, because the cavity preparation is initiated and completed without contact by or contamination from the fluids of the mouth. It also protects the patient from the possibility of aspirating or swallowing debris associated with preparation and restoration of the tooth. It retracts the lips, cheeks, tongue, and the marginal tissue to a mild degree, thereby providing better access and vision and protecting the soft tissues from medications that may be irritating or distasteful. The dentist is afforded some degree of protection from infectious conditions that may be present in the patient's mouth.

There is many designs of rubber dam, but in general regular rubber dam instrument are:
1—Punch.
2—Forceps.
3—Clamps.
4—Rubber sheet.
5—Frame.
6—Dental floss.

### Case Prior Art

Dentists usually use accessory clamps or dental floss ties to hold rubber dam sheet in place around the prepared teeth.

Rubber dam clamps are commonly known as devices designed to apply reciprocal mechanical forces to the sides of a tooth in order to be mechanically retained in position on that tooth to restrain a rubber dam sheet . . .
dental clamp consist of two jaws connected to each other by abow. Usually one jaw engages on facial surface of the tooth and the another one engages on lingual surface of the tooth and these two jaws hold rubber dam sheet in place and prevent it from moving or sliding from all directions
   The disadvantages (problems) of accessory clamps are:
   1—Accessory clamps usually are not stable in place (on tooth) and dentist may need to use flowable composite or impression compound to make the clamp more stable.

2—It may cause trauma to gingival tissues and irreversible gingival recession.
3—Limited access to the prepared tooth.
4—Dentist is unable to make retrial for all his restoration after using rubber dam in case of using accessory clamps.
5—It may interfere with placement of crown or any indirect restoration especially if any movement happened on the clamp during lutting and that will make the restoration not seated on its place after lutting.

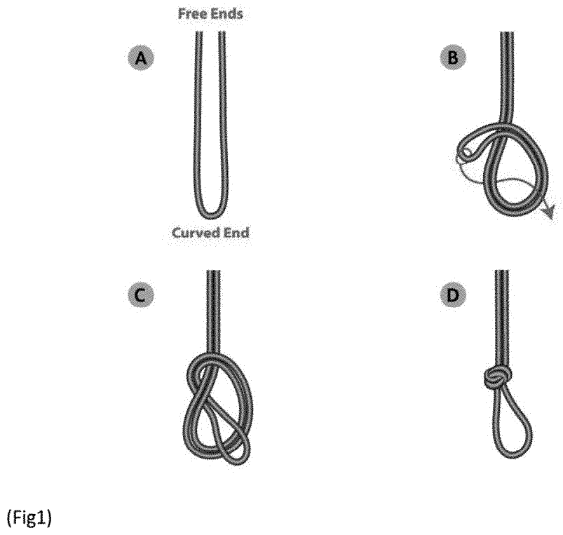

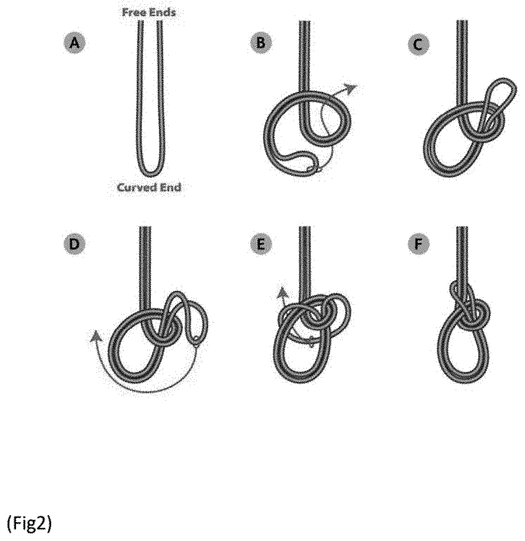

Generally, a dental floss tie consists of one or two loops, a knot and two free arms (FIG. 1) (FIG. 2).

The knot of the dental floss tie play the role of the clamp jaw in holding the rubber dam sheet in place around the prepared teeth.

The disadvantage (problem) of dental floss tie is that it has only one knot so it makes good tissue retraction from labial surface of the tooth because the knot hold the rubber dam sheet in place and prevent it from sliding over the loop from label while there is no knot in the palatal surface to hold rubber dam sheet in place and prevent it from sliding over the loop of the dental floss tie.

The idea of this invention is the following:

Creating new dental floss tie that has two or three or multi knots so these knots can hold rubber dam sheet in place around the tooth and prevent the rubber dam sheet from sliding over the loop from all surfaces of the tooth.

### A DETAILED EXPLANATION OF THE INVENTION

### Compound Dental Floss Tie

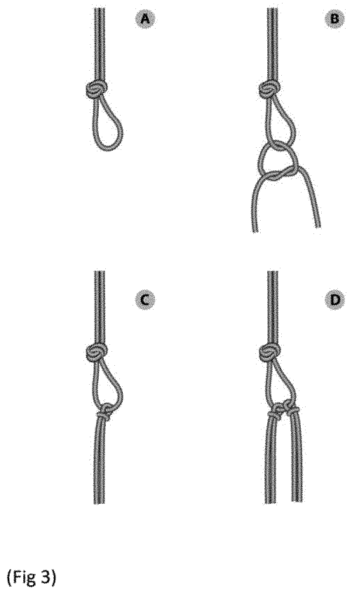

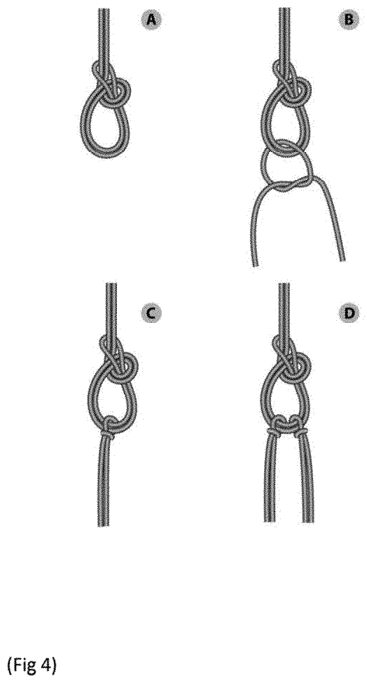

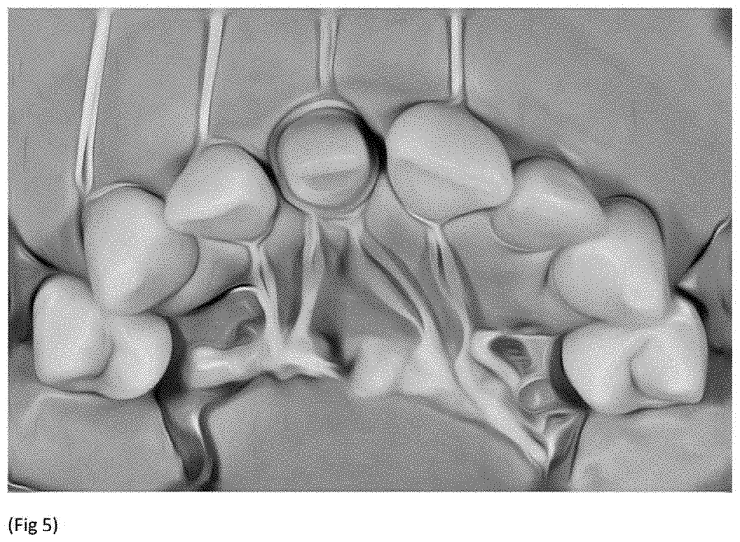

It consists of a single loop or double loop self-ligaturing tie attached to one, two or multiple regular ties. So I first made single loop or double loop self-ligaturing tie then I tied one or two or multiple regular ties to the loop of the first tie (FIG. 3) (FIG. 4) (FIG. 5).

This tie is designed to isolate prepared teeth for crowns, bridges or deep margin cavities; especially palatal and lingual cavities. It provides complete access to prepared teeth and perfect isolation by the rubber dam.

The advantages of Compound dental floss tie:
1—Perfect rubber retraction from vestibular and lingual surfaces of the prepared
teeth.
2—Good access to the prepared teeth.
3—Dentist can make retrial for full mouth indirect restoration after rubber dam
placement.
4—The tie is stable on the tooth so it is less traumatic to soft tissues.
5—Disposable so no need for sterilization and better for infection control.

### BRIEF DESCRIPTION OF THE DRAWINGS

(FIG. 1): (A)(B)(C)(D) step by step the technique of tying Single loop self-ligaturing tie.

(FIG. 2): (A)(B)(C)(D)(E)(F) step by step the technique of tying Double loop self-ligaturing tie.

(FIG. 3). (A)(B)(C)(D) step by step the technique of tying Compound dental floss tie consist of single loop self-ligaturing tie tied to one or two or multiple regular ties.

(FIG. 4). (A)(B)(C)(D) step by step the technique of tying Compound dental floss tie consist of double loop self-ligaturing tie tied to one or two or multiple regular ties.

(FIG. 5): Compound dental floss tie on right central incisor consists of double loop self-ligaturing tie tied to two regular ties.

1- The new Compound dental floss tie is made by Connecting or tying one regular tie to the loop of single loop or double loop self-ligaturing tie.

2- Compound dental floss tie as defined in claim 1, wherein Connecting or tying two regular ties to the loop of single loop or double loop self-ligaturing tie.

3- Compound dental floss tie as defined in claim 1, wherein Connecting or tying multiple regular ties to single loop or double loop self-ligaturing tie.

4- Compound dental floss tie as defined in claim 1, wherein connecting or tying any kind of knots or ties to the loop of single loop or double loop self-ligaturing tie.

5- Compound dental floss tie as defined in claim 1, where in using any kind of wire instead dental floss.
